(19) United States
(12) Patent Application Publication
(10) Pub. No.: US 2007/0073757 A1
(43) Pub. Date: Mar. 29, 2007

(54) Method and arrangement for the visualisation of data

(75) Inventors: Ludvig Karlsson, Stockholm (SE); Stefan Odelfalk, Stockholm (SE)

Correspondence Address: YOUNG & THOMPSON, 745 SOUTH 23RD STREET, 2ND FLOOR, ARLINGTON, VA, 22202, US

(73) Assignee: Panopticon Software ab, Stockholm (SE)

(21) Appl. No.: 10/553,962

(22) PCT Filed: Dec. 22, 2003
(86) PCT No.: PCT/SE03/02063

§ 371 Date: Oct. 4, 2006

(30) Foreign Application Priority Data
Dec. 20, 2002 (SE) 0203808-1

(51) Int. Cl. G06F 7/00

(52) U.S. Cl. 707/102

(57) ABSTRACT

A method and arrangement for the creation of a visualisation of data through “tree-mapping” displayed on a monitor with the aid of a computer, in which a structured tree is used to organize data, which data is visually presented through a map consisting of geometric elements. The geometric elements correspond to offspring of the root of the tree and together represent the highest level of the tree and completely fill an outer frame.

The present invention relates to the visualisation of data by the use of what is known as “tree-mapping”.

Tree-mapping is a known technique in which a structured tree is used to organise data and in which data are visually presented through a type of map consisting of, for example, a number of rectangles and squares that together fill the area within an outer frame.

The size of each element, that is, of each rectangle or square, corresponds to one parameter of the data that are stored in the tree, and a second parameter is represented by, for example, the colour of each rectangle or square. The elements, i.e. the rectangles and squares, normally completely fill the said frame.

One example of the use of what is known as “tree-mapping” is to make visible the size and the share price for companies on a stock exchange. In this case the surface area of each rectangle or square represents the stock exchange value of the relevant listed company, and the colour of the relevant rectangle or square represents the change in share price from, for example, the preceding trading day. The rectangles and the squares can represent, instead of the stock exchange value, the fraction of the share of the total trading volume on the preceding trading day. The rectangles and squares together completely fill the said frame, which is normally a rectangle. This means that the companies that are represented in the map, for example the 30 most frequently traded companies, fill 100% of the area of the frame. The various rectangles and squares are thus given proportions relative to each other. This type of tree-mapping provides an image of the stock exchange over which it is very easy to gain an overview, and which is very easy to understand.

The tree-mapping is based on a structured tree. The root has, for example, three offspring. One offspring in the example above may represent, for example, the pharmaceuticals sector, one offspring may represent manufacturing industry, and one offspring may represent the telecommunications industry. Each one of the three offspring has, for example, three offspring. For example, the offspring of the telecommunications industry may be telephone companies, system suppliers and telephone suppliers. Each of these nodes can, in turn, have three offspring. As an example, the node of telephone companies can have for its offspring Telia, Tele2 and Vodaphone, which are listed on the Stockholm stock exchange.

If the colour of a particular element corresponds to the change in share price since the previous trading day, such changes are to be calculated for each leaf and for its ancestors. The changes are then to be inserted into the relevant element.

The value of the contents of an inner node is the sum of the values of its offspring, i.e. in the example: the value of the telecommunications sector, the value of the telephone companies, and the individual values of the listed companies Telia, Tele2 and Vodaphone.

The structure of the tree may, of course, be freely chosen.

When a tree-mapping is to be carried out according to the example above, the stock exchange values of the said listed companies, those that are leaves, are requested. The sum of the values of these is calculated, and this sum forms the value for telephone operators, i.e. the parents of the leaves. This value is subsequently added to the values of the nodes for system suppliers and telephone suppliers, whereby that value of the node of the telecommunications industry is calculated.

The tree-mapping is often carried out at different levels. A highest level may be that a map of only the nodes at level 1 is displayed within the said frame. By marking a node by, for example, clicking on a computer monitor, the offspring of the parent can fill the complete frame. It is in this way possible to zoom in down to the lowest level.

The calculation and thus the execution of a tree-mapping of, for example, a stock exchange with hundreds of companies and in which different levels are present requires a long time due to the fact that the complete map is recalculated at each updating, based on the values in the lowest level. This means that tree-mapping of, for example, a stock exchange is carried out only at certain, long, intervals of time.

It is an intense desire to be able dynamically to change the map as the changes take place.

The present invention satisfies this desire.

The present invention thus relates to a method and an arrangement for the creation of a visualisation of data through what is known as “tree-mapping” displayed on a monitor with the aid of a computer, where tree-mapping is a known technique in which a structured tree is used to organise data, in which data is visually presented through a map consisting of geometric elements, such as a number of rectangles and squares, which geometric elements correspond to offspring of the root of the tree and which together represent the highest level of the tree and which together completely fill an outer frame, and in which the size of each element, i.e. the size of each rectangle or square, corresponds to the value of one parameter of the data that are stored in the nodes of the tree, and in which a second parameter is represented by, for example, the colour of each rectangle or square, and in which one or several of the said elements can be subdivided into smaller elements, corresponding to a branching of the tree, where the smaller elements represent a lower level, and where the smaller elements together wholly or partially fill the area of the level that lies immediately above and where the said smaller elements in a corresponding manner can be further subdivided into further smaller elements, corresponding to a further branching, which further smaller elements represent a further lower level, etc., and is characterised in that when a change of the value of one parameter takes place at one node, the value of the parent of the node in the direction towards higher levels is recalculated, based on the node in which the change has taken place, until the value of the said elements along the relevant pathway of calculation and the value of the said geometric elements have been calculated, leading to the sizes of the geometric elements at the highest level have relative proportions assigned to them taking into account the said changed value such that the said frame is completely filled, and in that all elements have relative proportions assigned to them relative to the changed area at the immediately higher level.

The invention is described below in more detail in association with an embodiment shown in the attached drawings, where:

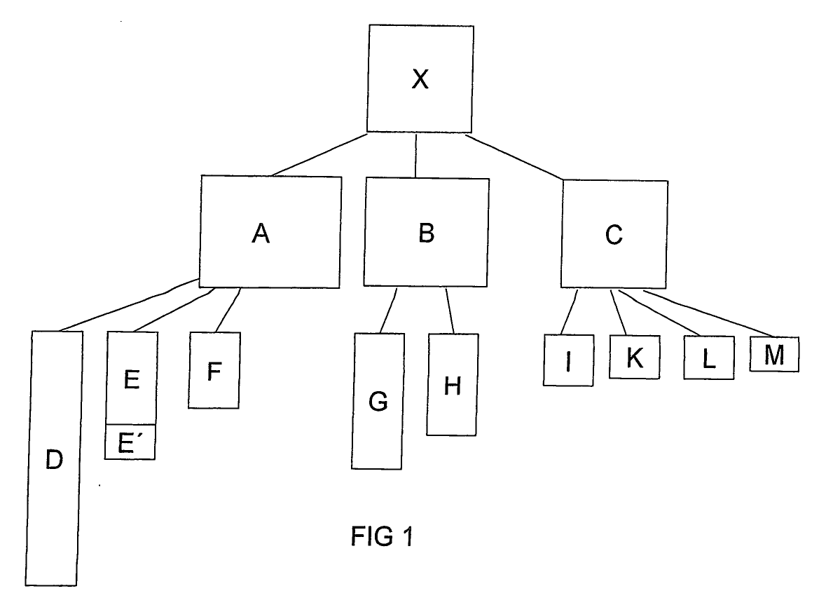

FIG. 1 illustrates a tree structure

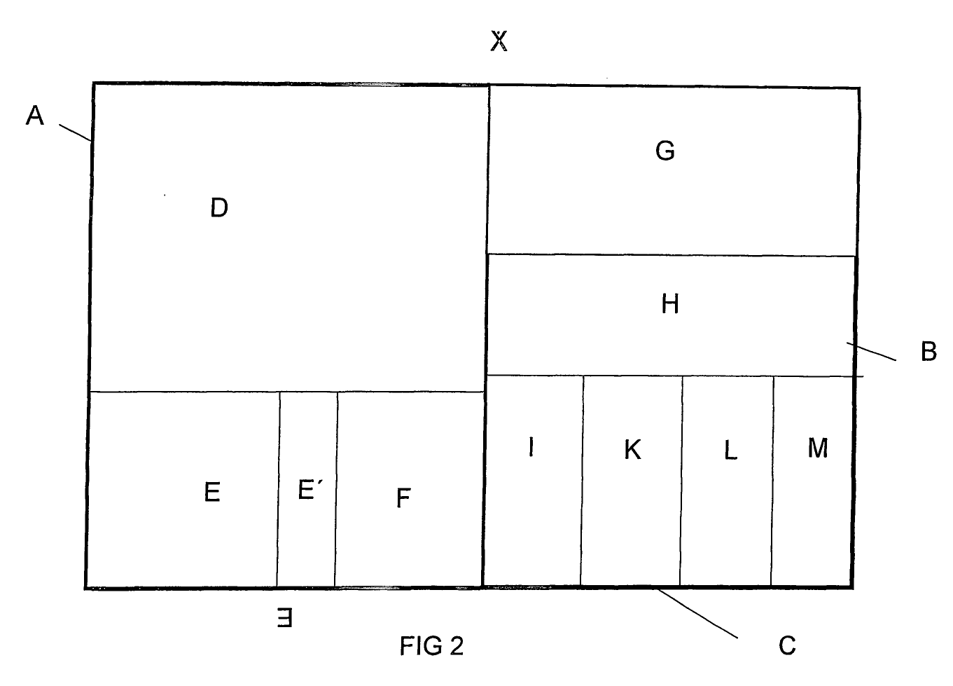

FIG. 2 illustrates a map.

A tree that is used to organise data is shown in FIG. 1.

Thi s data are presented visually in FIG. 2 through a map consisting of geometric elements, such as a number of rectangles and squares.

X in FIG. 1 represents the root of the tree. The reference symbols A, B and C represent offspring of the root of the tree and are thus the next level of the tree. The reference symbols D, E and F represent offspring of the node A. The reference symbols G and H represent offspring of the node B. The reference symbols I, K, L and M represent branches from the node C. The reference symbols D to M are located at a lower level in the tree than the level of A to C.

The geometrical elements in FIG. 2 have the same reference symbols as those in FIG. 1. Thus, the elements A, B and C in FIG. 2 represents offspring of the root of the tree, which elements together represent the next highest level of the tree and which together completely fill the outer frame. Each element A-M is a node, the area of which, i.e. the size of each rectangle or square, corresponds to the value of one parameter in the data that are stored in the tree, and where a second parameter is represented by, for example, the colour of each rectangle or square.

One or several of the said elements A-C can be subdivided into smaller elements D-F; G-H; I-M; where the smaller elements represent a lower level, and where the smallest elements together fill completely the area A-C of the highest level, and where the said smaller elements can be subdivided in an equivalent manner into further smaller elements, corresponding to a branching of the tree, which further smaller elements represent a further lower level, etc.

The figures can as an example be considered to represent a stock exchange X, such as the Stockholm stock exchange. The area of the outer rectangle in FIG. 2 thus represents the complete stock exchange value for the three sectors A, B and C, for which the telecommunications industry, the pharmaceuticals sector and manufacturing industry have been above taken as examples. The area A relative to the outer rectangle thus corresponds to the value of the telecommunications industry relative to the remainder.

As FIG. 2 makes clear, the element A can be subdivided into smaller elements D, E and F corresponding to the values for telephone operators, system suppliers and telephone suppliers. The elements B and C can, in a corresponding manner be subdivided into smaller elements at a lower level.

In order to place the said geometric elements with a surface area that corresponds to, for example, the value of a company, it is important that the companies are arranged in order of size. This is illustrated in FIG. 1. The reason for this is that the largest element must be placed first, followed by the next largest, etc., since the elements together will completely fill an element at the next highest level.

What has been described above in association with FIGS. 1 and 2 is the prior art.

The present invention concerns a method and an arrangement to carry out dynamic changes in a map equivalent to the one shown in FIG. 2.

When a change in the value of a parameter takes place at a node, as is illustrated in FIG. 1 by the element E′, only the value for the ancestors of the node in the direction towards higher levels based on the node in which the change has taken place is recalculated, according to the invention, until the value of the said elements along the relevant pathway of calculation D, E, F, A and the value of the said geometric element A at the highest level have been calculated, which leads to the size of the geometric elements A, B, C at the highest level are given mutual proportions taking into consideration the said changed value such that the said frame is completely filled, and to all elements G, H, I, K, L, M at lower levels are given mutual proportions relative to the changed areas B, C at the next highest level.

This means that the elements E and A are recalculated based on the change, while other elements are given the correct proportions.

This method involves a very great saving in time with respect to the necessary calculations. It can be shown that if the tree has N nodes, which requires of the order of N calculations in order to update the map when using traditional management of the tree, it is adequate when using the present invention to carry out of the order of log(N) calculations, where the base of the logarithm is the average degree of nodes in a tree, and where log(N) is thus an approximation of the height of the tree.

This increased speed of calculation makes it possible to achieve a dynamic “tree-mapping”, in which the user experiences that the map that is displayed is continuously updated.

It is intended that the said “change of value” of a node is to denote that a node has changed its value, or has been removed or added.

According to one preferred embodiment, a calculation is caused to take place for changes that exceed a certain amount. No updating is carried out in the case in which a change is so small that the human eye would not be able to appreciate any difference between a recalculated element relative to the surrounding correctly proportioned elements. It is preferred that it should be possible to select the said certain amount through an instruction to a computer that is present.

It has been mentioned above that further parameters may be present and can be mirrored in, for example, the colour of a particular element. Such parameters may be sums, minima, maxima, mean value or variances, or other parameters that depend on the area in which the tree-mapping has been applied.

According to one preferred embodiment, one or more parameters, such as colour, of the said elements, will be caused to be updated following the calculation of the distribution of area among the elements present.

Tree-mapping has been described above using as an example the visualisation of a stock exchange. It can, however, be applied in totally different areas such as retail trade, where each element represents, for example, the sales of goods within a product group and where the colour of the element can be a measure of the availability of goods within the relevant product group. A second example may be within the travel industry, in order to obtain an overview of the booking situation, etc.

Furthermore, the relative location of an element in a rigid order may, instead of surface area, be one parameter, and the colour, for example, of the elements may be a second parameter.

It can also be arranged such that the displayed elements do not completely fill the outer frame, and that outside of and, possibly, between the elements displayed can unused areas be present that form, for example, a background to the elements displayed.

The present invention thus is not to be considered to be limited to any particular application. Nor is the invention to be considered to be limited to the geometric design of the maps.

Thus the invention is not to be considered to be limited to the embodiments described above, but it can be varied within the framework specified by the attached claims.

1-10. (canceled)

11. In a method for displaying parameters of a set of companies that have been tree-mapped into plural levels wherein the companies are nodes at one level of the tree-map and nodes at subsequent levels up the tree-map from the one level are groups of companies sorted by predetermined characteristics, wherein the method includes displaying a frame that has a shape of a first geometrical figure and has plural second geometrical figures within the frame, showing relative values of a first parameter of the companies at selected tree-map levels as relative sizes of the second geometrical figures within the frame and showing relative values of a second parameter of the companies at the selected tree-map levels as different colors of the second geometrical figures within the frame, the improvement wherein the method further comprises the steps of:
when a change in the first parameter occurs at one of the nodes of the tree-map, recalculating values of the first parameter for ancestors of the one node at each level in a direction up the tree-map starting at the one node until a highest tree-map level is reached without recalculating values of the first parameter for nodes other than the one node and ancestors of the one node;
completely filling the frame with the second geometrical figures by reapportioning the relative sizes of the second geometrical shapes of nodes other than the one node and ancestors of the one node based on the recalculated value of the first parameter of the one node and of ancestors of the one node; and
displaying the frame with revised relative sizes of the second geometrical figures at selected levels of the tree-map to a user of information conveyed by the first and second parameters.

12. The improved method of claim 11, wherein the first and second parameters are selected from the group of parameters consisting of a value of a company, a fraction of a trading volume, and a change of share price.

13. The improved method of claim 11, wherein the displaying step includes displaying relative values of companies or groups of companies as the relative sizes of the second geometrical figures and displaying a change of share price of the companies or groups of companies as colors of the respective second geometrical figures.

14. The improved method of claim 13, further comprising the step of visualizing sizes and share price changes of companies and groups of companies on a stock exchange based on the information conveyed within the displayed frames at different tree-map levels.

15. The improved method of claim 11, wherein the first and second geometrical figures are rectangles or squares.

16. The improved method of claim 11, further comprising the step of revising the colors of the second geometrical figures following the step of completely filling the frame and before displaying the frame.

17. In a method for displaying parameters of companies on a stock exchange that have been tree-mapped into plural levels wherein the companies are nodes at one level of the tree-map and nodes at subsequent levels up the tree-map from the one level are groups of companies sorted into industry sectors, wherein the method includes displaying a frame that has a shape of a first geometrical figure and has plural second geometrical figures within the frame, showing relative values of the companies or groups of companies at selected tree-map levels as relative sizes of the second geometrical figures within the frame and showing a change of share price of the companies or groups of companies at the selected tree-map levels as different colors of the second geometrical figures within the frame, the improvement wherein the method further comprises the steps of:
when a value of one of the companies at one of the nodes of the tree-map changes, recalculating values for ancestors of the one node at each level in a direction up the tree-map starting at the one node until a highest tree-map level is reached without recalculating values of companies at nodes other than the one node and ancestors of the one node;
completely filling the frame with the second geometrical figures by reapportioning the relative sizes of the second geometrical shapes of nodes other than the one node and ancestors of the one node based on the recalculated values of the company at the one node and of the ancestors of the one node;
revising the colors of the second geometrical figures based on changes in share price; and
visualizing sizes and share price changes of the companies and groups of companies by displaying the frame with revised relative sizes and colors of the second geometrical figures at selected levels of the tree-map.

18. The improved method of claim 17, wherein the first and second geometrical figures are rectangles or squares.
